(19) United States
(12) Patent Application Publication
(10) Pub. No.: US 2026/0360189 A1
(43) Pub. Date: Nov. 12, 2026

(54) VEHICLE-MOUNTED APPARATUS, COMMUNICATION CONTROL METHOD, AND COMMUNICATION SYSTEM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Tsubasa KANAMORI, Osaka-shi, Osaka (JP); Makoto CHUJO, Osaka-shi, Osaka (JP); Yuichi KODAMA, Osaka-shi, Osaka (JP); Isao WATANABE, Toyota-shi, Aichi (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/117,509

(22) PCT Filed: Sep. 29, 2023
(86) PCT No.: PCT/JP2023/035629

§ 371 Date: Apr. 1, 2025

(30) Foreign Application Priority Data
Oct. 7, 2022 (JP) 2022-162107

(51) Int. Cl. G07C 5/00; H04L 12/40

(52) U.S. Cl. CPC G07C 5/008; H04L 12/40032; H04L 2012/40215; H04L 2012/40273

(57) ABSTRACT

A vehicle-mounted apparatus mounted in a vehicle includes: an acquisition unit configured to acquire vehicle information, which relates to the vehicle, and measurement result information, which includes a measurement result that relates to the vehicle-mounted apparatus and is a measurement result of an object of measurement which affects transmission of the vehicle information; and a communication unit configured to transmit the vehicle information and the measurement result information acquired by the acquisition unit to a management apparatus.

### CROSS-REFERENCE TO RELATED APPLICATIONS

This application is the U.S. national stage of PCT/JP2023/035629 filed on Sep. 29, 2023, which claims priority of Japanese Patent Application No. JP 2022-162107 filed on Oct. 7, 2022, the contents of which are incorporated herein.

### TECHNICAL FIELD

The present disclosure relates to a vehicle-mounted apparatus, a communication control method, and a communication system.

### BACKGROUND

Japanese U.S. Pat. No. 4,107,238 discloses the vehicle-mounted communication system described below. This vehicle-mounted communication system is a vehicle-mounted communication system where communication is performed via a network between an information center and vehicle-mounted terminal apparatuses mounted in a plurality of vehicles and includes: a step of regularly transmitting, as information on an actual driving environment, information including vehicle position information and cumulative vehicle mileage information, from the respective vehicle-mounted terminal apparatuses to the information center; a step of transmitting failure occurrence information and diagnostic information from the vehicle-mounted terminal apparatus of a vehicle that has experienced a failure to the information center; a step of the information center extracting, from a vehicle information database, vehicles whose manufacturing conditions and/or environmental conditions, such as information on the actual driving environment and information on the vehicle environment is/are similar to the vehicle that has experienced a failure; a step of the information center requesting the extracted vehicles to transmit diagnostic information to the information center; a step of transmitting diagnostic information from the vehicle-mounted terminal apparatuses of the extracted vehicles to the information center; a step of the information center associating and analyzing the diagnostic information of the extracted vehicles, the position information of the extracted vehicles, and meteorological information and topographical information of the positions.

In the past, a technology for detecting abnormalities relating to a vehicle has been disclosed.

There is demand for a technology capable of improving the detection accuracy of abnormalities relating to a vehicle compared to the technology disclosed in Japanese U.S. Pat. No. 4,107,238.

The present disclosure was conceived to solve the problem described above and has an object of providing a vehicle-mounted apparatus, a communication control method, and a communication system capable of improving the detection accuracy of abnormalities relating to a vehicle.

### SUMMARY

A vehicle-mounted apparatus according to an aspect of the present disclosure is a vehicle-mounted apparatus mounted in a vehicle and includes: an acquisition unit configured to acquire vehicle information, which relates to the vehicle, and measurement result information, which includes a measurement result that relates to the vehicle-mounted apparatus and is a measurement result of an object of measurement which affects transmission of the vehicle information; and a communication unit configured to transmit the vehicle information and the measurement result information acquired by the acquisition unit.

Another aspect of the present disclosure may be realized not only as a vehicle-mounted apparatus equipped with the characteristic processing units described above but also as a program that causes a computer to execute steps with the characteristic processing. Another aspect of the present disclosure may be realized as a semiconductor integrated circuit that realizes part or all of the vehicle-mounted apparatus.

### Advantageous Effects

According to the present disclosure, it is possible to improve the detection accuracy for abnormalities relating to a vehicle.

### BRIEF DESCRIPTION OF DRAWINGS

FIG. 1 is a diagram depicting the configuration of a communication system according to an embodiment of the present disclosure.

FIG. 2 is a diagram depicting the configuration of a vehicle-mounted apparatus according to an embodiment of the present disclosure.

FIG. 3 is a diagram depicting an example configuration of a vehicle information acquisition unit in a vehicle-mounted apparatus according to an embodiment of the present disclosure.

FIG. 4 is a diagram illustrating another example configuration of a vehicle information acquisition unit in a vehicle-mounted apparatus according to an embodiment of the present disclosure.

FIG. 5 is a diagram depicting one example of a CAN table stored by a vehicle-mounted apparatus according to an embodiment of the present disclosure.

FIG. 6 is a diagram depicting an example configuration of a measurement result information acquisition unit in a vehicle mounted apparatus according to an embodiment of the present disclosure.

FIG. 7 is a diagram useful in explaining a process of calculating the ratio of power supplying time per unit time by a vehicle-mounted apparatus according to an embodiment of the present disclosure.

FIG. 8 is a diagram depicting one example of measurement result information transmitted by a vehicle-mounted apparatus according to an embodiment of the present disclosure.

FIG. 9 is a diagram depicting the configuration of a management apparatus according to an embodiment of the present disclosure.

FIG. 10 is a diagram depicting one example of setting information stored by a management apparatus according to an embodiment of the present disclosure.

FIG. 11 is a diagram depicting another example of the setting information stored by the management apparatus according to an embodiment of the present disclosure.

FIG. 12 is a diagram depicting one example of a theoretical table stored by a management apparatus according to an embodiment of the present disclosure.

FIG. 13 is a diagram depicting one example of a collection record table stored by a management apparatus according to an embodiment of the present disclosure.

FIG. 14 is a flowchart defining an operational procedure when vehicle information and measurement result information are transmitted to a management apparatus by a vehicle-mounted apparatus according to an embodiment of the present disclosure.

FIG. 15 is a diagram depicting one example of a processing sequence of a vehicle-mounted apparatus and a management apparatus in a communication system according to an embodiment of the present disclosure.

FIG. 16 is a diagram depicting the sequence of an updating process for setting information in a communication system according to an embodiment of the present disclosure.

FIG. 17 is a diagram depicting one example of a collection record table stored in Modification 1 of a management apparatus according to an embodiment of the present disclosure.

FIG. 18 is a diagram depicting the configuration of Modification 2 of a vehicle-mounted apparatus according to an embodiment of the present disclosure.

FIG. 19 is a diagram depicting one example of a collection record table stored by Modification 2 of a management apparatus according to an embodiment of the present disclosure.

FIG. 20 is a diagram depicting the sequence of a setting process in Modification 3 to a communication system according to an embodiment of the present disclosure.

### DETAILED DESCRIPTION OF PREFERRED EMBODIMENTS

Several embodiments of the present disclosure will first be listed and described in outline.

In a first aspect, a vehicle-mounted apparatus according to an aspect of the present disclosure is a vehicle mounted apparatus mounted in a vehicle and includes: an acquisition unit configured to acquire vehicle information, which relates to the vehicle, and measurement result information, which includes a measurement result that relates to the vehicle-mounted apparatus and is a measurement result of an object of measurement which affects transmission of the vehicle information; and a communication unit configured to transmit the vehicle information and the measurement result information acquired by the acquisition unit to a management apparatus.

In this way, by using a configuration where vehicle information and measurement result information of an object of measurement that affects the transmission of vehicle information are transmitted to the management apparatus, it is possible for the management apparatus to grasp how the transmission of vehicle information is affected, which makes it possible to more accurately detect abnormalities relating to a vehicle. Accordingly, the accuracy of detecting abnormalities relating to a vehicle can be improved.

In a second aspect according to the first aspect, the measurement result information may include a measurement result relating to a power supplying unit that supplies electrical power in the vehicle.

With this configuration, the management apparatus can grasp the state of the power supplying unit that affects the transmission of vehicle information, which makes it possible to more accurately detect abnormalities relating to the vehicle.

In a third aspect according to the second aspect, the measurement result relating to the power supplying unit may include a ratio of time during which the electrical power is supplied by the power supplying unit per a predetermined unit time.

With this configuration, the transmission state of the vehicle information can be more accurately grasped in accordance with the length of time that the power supply unit has been supplying power.

In a fourth aspect according to the second or the third aspect, the measurement result relating to the power supplying unit may include a number of times the power supplying unit starts up per a predetermined unit time.

With this configuration, the transmission state of the vehicle information can be grasped more accurately in keeping with the number of times the power supply unit has started up.

In a fifth aspect according to any one of the first through the fourth aspects, the measurement result information may include a measurement result relating to communication quality between the communication unit and the management apparatus.

With this configuration, the transmission state of the vehicle information can be grasped more accurately in keeping with the communication quality between the communication unit and the management apparatus.

In a sixth aspect according to any one of the first through the fifth aspects, the acquisition unit may acquire the vehicle information based on setting information transmitted from the management apparatus.

With this configuration, as one example, even if a vehicle-mounted apparatus is added to a vehicle after the vehicle has left the factory, it will still be possible to transmit vehicle information to the management apparatus in the same way as with a vehicle-mounted apparatus that was installed in the vehicle before leaving the factory. Since it is also possible to set the type of vehicle information to be transmitted, for example, the location where an abnormality has occurred can be easily identified.

In a seventh aspect according to the sixth aspect, the communication unit may transmit version information, which indicates a version of the currently stored setting information to the management apparatus, and the communication unit may request the management apparatus to transmit new setting information based on determination information, which indicates a determination result on the version indicated by the version information, transmitted from the management apparatus.

With this configuration, since it is possible to reflect the latest setting information for example when transmitting vehicle information to the management apparatus, it is possible to further improve the accuracy with which the management apparatus can detect abnormalities relating to the vehicle.

In an eighth aspect according to any one of the first through the seventh aspects, the acquisition unit may acquire the vehicle information based on setting information transmitted from another apparatus that differs from the management apparatus, and the communication unit may also transmit the vehicle information acquired by the acquisition unit to the other apparatus.

With this configuration, vehicle information requested by the user of the vehicle for example can be transmitted to an apparatus aside from the management apparatus, which improves user convenience.

In a ninth aspect, a communication control method according to an aspect of the present disclosure is a communication control method for a vehicle-mounted apparatus mounted in a vehicle and may include: a step of acquiring vehicle information, which relates to the vehicle, and measurement result information, which includes a measurement result that relates to the vehicle-mounted apparatus and is a measurement result of an object of measurement which affects transmission of the vehicle information; and a step of transmitting the acquired vehicle information and measurement result information to a management apparatus.

In this way, by using a configuration where vehicle information and measurement result information of an object of measurement that affects the transmission of vehicle information are transmitted to the management apparatus, it is possible for the management apparatus to grasp the state in which the transmission of vehicle information is affected and to detect abnormalities relating to the vehicle more accurately. Accordingly, it is possible to improve the detection accuracy for abnormalities relating to vehicles.

In a tenth aspect, a communication system according to an aspect of the present disclosure includes: a vehicle-mounted apparatus mounted in a vehicle; and a management apparatus that detects an abnormality relating to the vehicle, wherein the vehicle-mounted apparatus includes: an acquisition unit configured to acquire vehicle information, which relates to the vehicle, and measurement result information, which includes a measurement result that relates to the vehicle-mounted apparatus and is a measurement result of an object of measurement which affects transmission of the vehicle information; and a communication unit configured to transmit the vehicle information and the measurement result information acquired by the acquisition unit to the management apparatus, and the management apparatus detects an abnormality based on the vehicle information and the measurement result information received from the communication unit.

In this way, by using a configuration where vehicle information and measurement result information of an object of measurement that affects the transmission of vehicle information are transmitted to the management apparatus, it is possible for the management apparatus to grasp the state in which the transmission of vehicle information is affected and to detect abnormalities relating to the vehicle more accurately. Accordingly, it is possible to improve the detection accuracy for abnormalities relating to vehicles.

Embodiments of the present disclosure will now be described with reference to the attached drawings. In the drawings, the same or corresponding parts have been assigned the same reference numerals, and description thereof will not be repeated. It is also possible to freely combine the embodiments described below, at least in part.

### Communication System

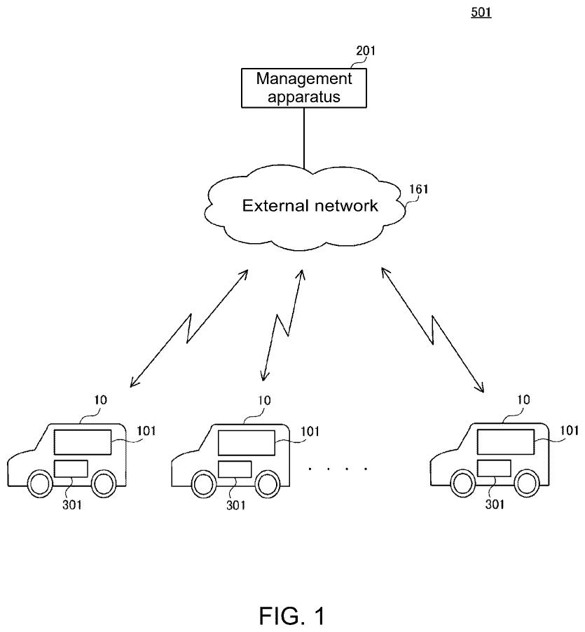

FIG. 1 is a diagram depicting the configuration of a communication system according to an embodiment of the present disclosure. As depicted in FIG. 1, a communication system 501 includes one or a plurality of vehicle-mounted apparatuses 101, a management apparatus 201, and terminal apparatuses 301. Each vehicle-mounted apparatus 101 and the management apparatus 201 are capable of transmitting and receiving information via an external network 161, such as the Internet. Each vehicle-mounted apparatus 101 is mounted in a vehicle 10.

As examples, the management apparatus 201 and the terminal apparatuses 301 are used by a business that manages the operation of the vehicles, or by individuals (these are hereinafter collectively referred to as “the user”). The management apparatus 201 is a server, for example. As examples, the terminal apparatuses 301 are communication terminal apparatuses, such as smartphones or tablets.

The management apparatus 201 receives, from the one or a plurality of vehicle-mounted apparatuses 101, vehicle information relating to the corresponding vehicles 10. The management apparatus 201 transmits setting information, which indicates a setting content for the vehicles 10 relating to transmission of vehicle information, to the vehicle-mounted apparatuses 101. The management apparatus 201 detects any abnormalities relating to a vehicle 10, such as a malfunction at that vehicle 10, based on vehicle information received from the vehicle-mounted apparatuses 101. Note that this setting information will be described in detail later.

Each vehicle-mounted apparatus 101 transmits vehicle information relating to the corresponding vehicle 10, which includes identification information for that vehicle 10, to the management apparatus 201. As one example, the vehicle information includes information relating to the running of the vehicle 10.

As a specific example, the vehicle-mounted apparatus 101 transmits position information, vehicle speed information, and the like of the corresponding vehicle 10 to the management apparatus 201. Note that the vehicle information is not limited to position information and vehicle speed information, and may be driving control information, such as braking operations of the vehicle 10. The vehicle information is also not limited to information related to the running of the vehicle 10, and may be information indicating images captured by a camera mounted on the vehicle 10 and information indicating a measurement result of a sensor mounted on the vehicle 10.

### Vehicle-Mounted Apparatus

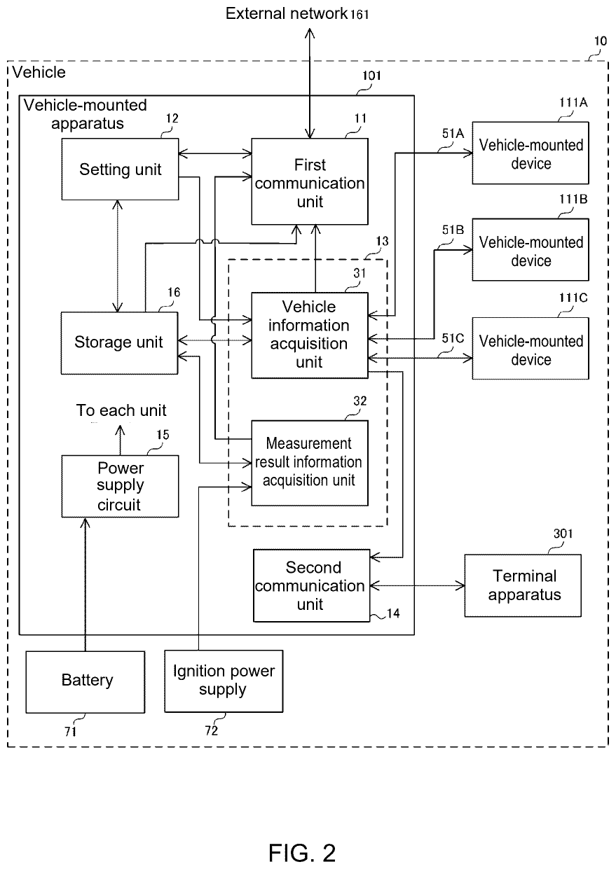

FIG. 2 is a diagram depicting the configuration of a vehicle-mounted apparatus according to an embodiment of the present disclosure. As depicted in FIG. 2, the vehicle-mounted apparatus 101 is connected to a plurality of vehicle-mounted devices 111 via a CAN bus 51 that conforms to CAN (Controller Area Network) (registered trademark) standard.

As examples, the vehicle-mounted devices 111 include an autonomous driving ECU (Electronic Control Unit), an engine ECU, a TCU (Telematics Communication Unit), a sensor, a navigation apparatus, a human machine interface, and a camera.

In the example depicted in FIG. 2, the vehicle-mounted apparatus 101 is connected to a plurality of vehicle-mounted devices 111, that is, the vehicle-mounted devices 111A, 111B, and 111C.

As one example, the vehicle-mounted apparatus 101 and the vehicle-mounted devices 111 operate using power supplied from a battery 71 of the vehicle 10.

The vehicle-mounted apparatus 101 includes a first communication unit 11, a setting unit 12, an acquisition unit 13, a second communication unit 14, a power supply circuit 15, and a storage unit 16. The acquisition unit 13 includes a vehicle information acquisition unit 31 and a measurement result information acquisition unit 32. As one example, the first communication unit 11, the setting unit 12, the acquisition unit 13, and the second communication unit 14 may be partly or entirely realized by processing circuitry including one or a plurality of processors. As one example, the storage unit 16 is a non-volatile memory included in this processing circuitry.

### First Communication Unit

The first communication unit 11 communicates with the management apparatus 201 via the external network 161 by performing wireless communication with a wireless base station (not illustrated) according to a communication method such as Wi-Fi (registered trademark), LTE (Long Term Evolution) (registered trademark), or 5G. As one example, the first communication unit 11 receives setting information that was transmitted from the management apparatus 201 via the external network 161 and outputs the received setting information to the setting unit 12. Note that the first communication unit 11 is not limited to a configuration that communicates with the management apparatus 201 via a wireless base station and the external network 161, and may be configured to communicate with the management apparatus 201 via a wired line. The first communication unit 11 may also be configured to communicate with the management apparatus 201 via another vehicle-mounted apparatus.

### Vehicle Information Acquisition Unit

The vehicle information acquisition unit 31 acquires vehicle information relating to the vehicle 10. The vehicle information acquisition unit 31 communicates with one or a plurality of vehicle-mounted devices 111 in accordance with CAN standard.

In the example depicted in FIG. 2, the vehicle information acquisition unit 31 is connected to the vehicle-mounted devices 111A, 111B, and 111C via CAN buses 51A, 51B, and 51C, which are three CAN buses 51. Hereinafter, the CAN bus 51A will also be referred to as “CAN1,” the CAN bus 51B will also be referred to as “CAN2,” and the CAN bus 51C will also be referred to as “CAN3.”

The vehicle-mounted apparatus 101 is not limited to a configuration in which three CAN buses 51 are connected to the vehicle information acquisition unit 31, and may be a configuration in which one or a plurality of CAN buses 51 are connected.

In addition, the vehicle-mounted apparatus 101 and each vehicle-mounted device 111 may be configured to communicate in accordance with a standard aside from CAN, such as CAN FD (CAN with Flexible Data Rate), Ethernet (registered trademark), FlexRay (registered trademark), MOST (Media Oriented System Transport) (registered trademark), and LIN (Local Interconnect Network).

Each vehicle-mounted device 111 transmits its own vehicle information to the vehicle information acquisition unit 31. The vehicle information transmitted from each vehicle-mounted device 111 via the CAN bus 51 is stored in a CAN frame assigned a CAN-ID (identifier) indicating the type of data and the like. In the following description, it is assumed that the CAN-ID of each CAN frame storing vehicle information of the vehicle-mounted device 111A is “001”, the CAN-ID of each CAN frame storing vehicle information of the vehicle-mounted device 111B is “002”, and the CAN-ID of each CAN frame storing the vehicle information of the vehicle-mounted device 111C is “003”.

When setting information has been received from the first communication unit 11, the setting unit 12 stores the received setting information in the storage unit 16 and performs a setting process relating to the transmission of vehicle information based on this setting information. As one example of the setting process, the setting unit 12 makes settings so that vehicle information corresponding to the type of data indicated by the setting information is transmitted to the management apparatus 201.

As one example, when setting information indicating CAN-ID “001” has been received, as the setting process, the setting unit 12 sets the vehicle information acquisition unit 31 so that the vehicle information contained in a CAN frame with the CAN-ID “001” is transmitted to the management apparatus 201.

In more detail, when the vehicle information acquisition unit 31 regularly or irregularly acquires vehicle information transmitted from the vehicle-mounted device 111A, the setting unit 12 sets the vehicle information acquisition unit 31 to output the vehicle information included in CAN frames with the CAN-ID “001” to the first communication unit 11. In addition, the setting unit 12 sets the first communication unit 11 to transmit the vehicle information received from the vehicle information acquisition unit 31 to the management apparatus 201.

On the other hand, when the vehicle information acquisition unit 31 has not acquired vehicle information from the vehicle-mounted device 111A, as the setting process, the setting unit 12 requests, via the vehicle information acquisition unit 31, the vehicle-mounted device 111A to transmit vehicle information. On receiving a request from the vehicle-mounted apparatus 101, the vehicle-mounted device 111A transmits CAN frames with the CAN-ID “001” to the vehicle-mounted apparatus 101 regularly or irregularly. The setting unit 12 also sets the vehicle information acquisition unit 31 to output vehicle information included in the CAN frames with the CAN-ID “001” to the first communication unit 11. The setting unit 12 also sets the first communication unit 11 to transmit the vehicle information received from the vehicle information acquisition unit 31 to the management apparatus 201.

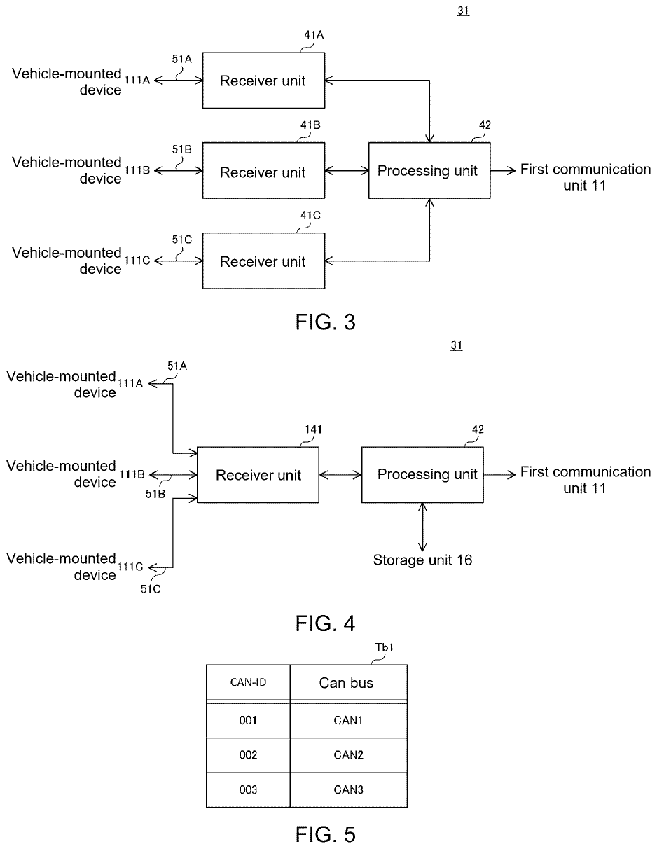

FIG. 3 is a diagram depicting an example configuration of a vehicle information acquisition unit in a vehicle-mounted apparatus according to an embodiment of the present disclosure. As depicted in FIG. 3, the vehicle information acquisition unit 31 includes a plurality of receiver units 41 and a processing unit 42.

The plurality of receiver units 41 are provided to individually correspond to the plurality of CAN buses 51. In the example depicted in FIG. 4, the vehicle information acquisition unit 31 includes three receiver units 41A, 41B, and 41C as the plurality of receiver units 41. The receiver units 41A, 41B, and 41C are provided so as to correspond to the CAN buses 51A, 51B, and 51C, respectively.

When a receiver unit 41 has received a CAN frame from a vehicle-mounted device 111 via the corresponding CAN bus 51, the receiver unit 41 stores the received CAN frame in a buffer (not illustrated) and notifies the processing unit 42 that a frame has been stored.

If, when the processing unit 42 has received notification of the storage of a CAN frame from a receiver unit 41, the CAN-ID included in the setting information in the storage unit 16 matches the CAN-ID of the CAN frame stored in a buffer of that receiver unit 41, the processing unit 42 selects the vehicle information included in the CAN frame stored in that buffer as vehicle information to be transmitted to the management apparatus 201. The processing unit 42 outputs the selected vehicle information to the first communication unit 11 and the second communication unit 14.

FIG. 4 is a diagram illustrating another example configuration of a vehicle information acquisition unit in a vehicle mounted apparatus according to an embodiment of the present disclosure. As depicted in FIG. 4, this vehicle information acquisition unit 31 includes one receiver unit 141 and the processing unit 42.

When the receiver unit 141 has received a CAN frame via the respective CAN buses 51, the receiver unit 141 stores the received CAN frame in a buffer (not illustrated) and outputs a notification of the storage of that CAN frame to the processing unit 42.

FIG. 5 is a diagram depicting one example of a CAN table stored by a vehicle-mounted apparatus according to an embodiment of the present disclosure.

As depicted in FIG. 5, the storage unit 16 stores a CAN table Tb1 indicating the correspondence between CAN-IDs and the CAN buses 51. As one example, a CAN table Tb1 indicates the correspondence between the type of data included in CAN frames and the CAN bus 51 on which such CAN frames are transmitted.

In the CAN table Tb1, the CAN bus 51 on which CAN frames with the CAN-ID “001” are transmitted is “CAN1”. The CAN bus 51 on which the CAN frames with the CAN-ID “002” are transmitted is “CAN2”. The CAN bus 51 on which the CAN frames with CAN-ID “003” are transmitted is “CAN3”.

When the processing unit 42 has received notification of the storage of a CAN frame from the receiver unit 141, the processing unit 42 reads out the CAN frame stored in the buffer of the receiver unit 141. The processing unit 42 refers to the CAN table in the storage unit 16 and identifies the CAN bus 51 corresponding to the CAN-ID included in the CAN frame that has been read out. By doing so, the processing unit 42 determines that a CAN frame transferred on the identified CAN bus 51 has been received. If CAN frames with the CAN-ID set in the setting process match the CAN-ID of the CAN frame stored in the buffer of the receiver unit 141, the processing unit 42 selects the vehicle information included in the CAN frame stored in that buffer as the vehicle information to be transmitted to the management apparatus 201. The processing unit 42 outputs the selected vehicle information to the first communication unit 11 and the second communication unit 14.

As depicted in FIG. 2, the first communication unit 11 transmits the vehicle information received from the vehicle information acquisition unit 31 to the management apparatus 201.

### Second Communication Unit

As one example, the second communication unit 14 communicates with the terminal apparatus 301 according to a USB (Universal Serial Bus) communication method. Note that the second communication unit 14 and the terminal apparatus 301 may be configured to perform wireless communication according to a standard such as Bluetooth (registered trademark).

The second communication unit 14 transmits the vehicle information received from the vehicle information acquisition unit 31, that is, the vehicle information acquired by the vehicle information acquisition unit 31, to the terminal apparatus 301.

The terminal apparatus 301 outputs the received vehicle information. As one example, the terminal apparatus 301 displays the content of the received vehicle information on its own display unit.

### Power Supply Circuit

The power supply circuit 15 supplies power to each unit in the vehicle-mounted apparatus 101. As one example, the power supply circuit 15 converts a voltage supplied from a battery 71 mounted on the vehicle 10 to a voltage of a predetermined level and outputs the converted voltage to each unit.

The ignition power supply 72 is switched between an ON state, where power is supplied to the power supply circuit 15, and an OFF state, where the supplying of power to the power supply circuit 15 is stopped, in accordance with a predetermined operation by the user. This ignition power supply 72 is one example of a “power supplying unit” that supplies electrical power to the vehicle 10.

In response to this, the vehicle-mounted apparatus 101 according to an embodiment of the present disclosure solves this problem by using the configuration and operations described below.

### Measurement Result Information Acquisition Unit

As depicted in FIG. 2, the measurement result information acquisition unit 32 acquires measurement result information including a measurement result which is related to the vehicle-mounted apparatus 101 and is for an object of measurement that affects the transmission of the vehicle information. Here, a case where the object of measurement is the ignition power supply 72 will be described. Note that the object of measurement is not limited to the ignition power supply 72, and may be another power supplying unit.

The measurement result information includes a measurement result relating to the ignition power supply 72. As one example, the measurement result relating to the ignition power supply 72 includes the ratio of the time during which power is supplied by the ignition power supply 72 per predetermined unit time. Hereinafter, the ratio of time during which power is supplied by the ignition power supply 72 per unit time is also referred to as the “power supplying ratio”.

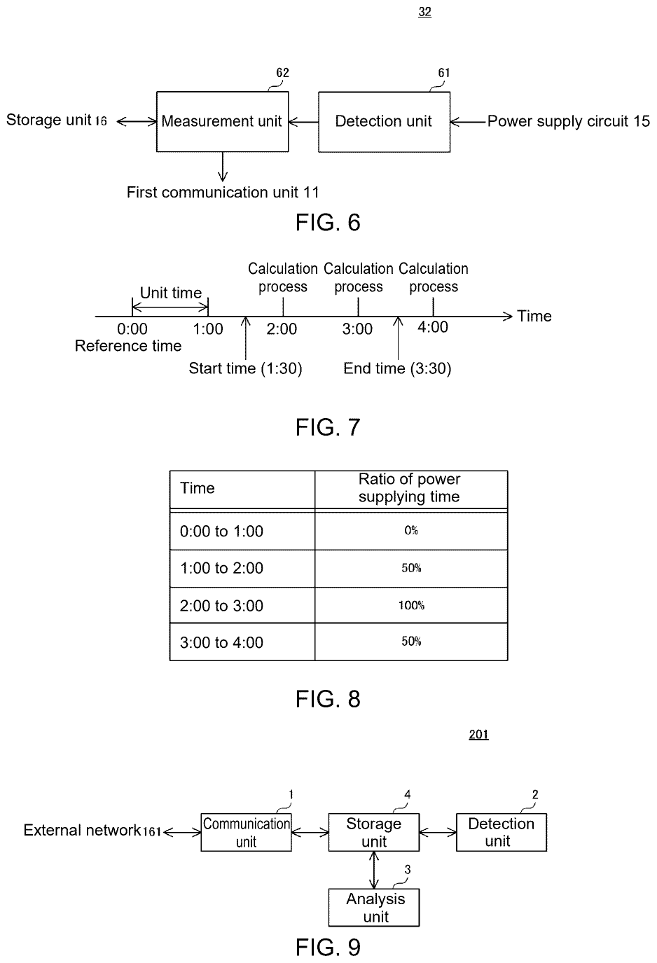

FIG. 6 is a diagram depicting an example configuration of a measurement result information acquisition unit in a vehicle-mounted apparatus according to an embodiment of the present disclosure. As depicted in FIG. 6, the measurement result information acquisition unit 32 includes a detection unit 61 and a measurement unit 62.

The detection unit 61 monitors the output voltage of the ignition power supply 72 to detect when the ignition power supply 72 is switched on and off.

As a more detailed example, the detection unit 61 measures the output voltage of the ignition power supply 72 to detect whether the ignition power supply 72 is on or off. If the measured voltage value is equal to or greater than a predetermined threshold, the detection unit 61 determines that the ignition power supply 72 is on, but if the measured voltage value is less than the threshold, the detection unit 61 determines that the ignition power supply 72 is off. The detection unit 61 notifies the measurement unit 62 that the ignition power supply 72 has switched from the on state to the off state, or from the off state to the on state.

FIG. 7 is a diagram useful in explaining a process of calculating the ratio of power supplying time per unit time by a vehicle-mounted apparatus according to an embodiment of the present disclosure.

As depicted in FIG. 7, when the measurement unit 62 has been notified by the detection unit 61 of the ignition power supply 72 switching to the on state, the measurement unit 62 starts a calculation process to calculate the ratio of the power supply time per unit time. In the example depicted in FIG. 7, the “unit time” is one hour. In the following description, the ratio of the power supplying time per unit time is also referred to as the “power supplying ratio.”

Next, the measurement unit 62 synchronizes time between the vehicle-mounted apparatus 101 to which it belongs and a GPS (Global Positioning System) receiver, which is one example of a vehicle-mounted device 111. As one example, the measurement unit 62 synchronizes time with a GPS receiver based on time synchronization information received from the GPS receiver, sets the present time of the vehicle-mounted apparatus 101 to which the measurement unit 62 belongs, and stores the present time as a start time in the storage unit 16. In the example depicted in FIG. 7, the start time is “1:30.”

Next, the measurement unit 62 calculates the power supplying ratio every time one hour elapses starting from a reference time set in advance. The measurement unit 62 stores the calculation result in the storage unit 16. In the example depicted in FIG. 7, the reference time is “0:00”, and the calculation process is performed from “2:00”.

Next, when the measurement unit 62 has been notified by the detection unit 61 that the ignition power supply 72 has been switched to the off state, the measurement unit 62 stores the present time as the end time in the storage unit 16. The measurement unit 62 also calculates the power supplying ratio at this end time. In the example depicted in FIG. 7, the end time is “3:30”.

The measurement unit 62 creates measurement result information including a calculation result obtained from the start time to the end time, and outputs the created measurement result information to the first communication unit 11.

The first communication unit 11 transmits the measurement result information received from the measurement unit 62 to the management apparatus 201. Note that the measurement unit 62 may create the measurement result information based on information acquired from a vehicle-mounted device that monitors switching on and off of the ignition power supply 72.

FIG. 8 is a diagram depicting one example of measurement result information transmitted by a vehicle-mounted apparatus according to an embodiment of the present disclosure.

As depicted in FIGS. 7 and 8, since the ignition power supply 72 is off in the period where the time is “0:00-1:00”, the power supplying ratio per hour is “0%”. During the period where the time is “1:00-2:00”, the ignition power supply 72 is switched on at “1:30”, so that power is supplied for 30 minutes from “1:30” to “2:00”, resulting in a power supplying ratio per hour of “50%”. During the period where the time is “2:00-3:00”, power is constantly supplied by the ignition power supply 72, so that the power supplying ratio per hour is “100%”. During the period where the time is “3:00-4:00”, the ignition power supply 72 is switched off at “3:30”, so that power is supplied for 30 minutes from “3:00” to “3:30”, resulting in a power supplying ratio of “50%”.

### Management Apparatus

FIG. 9 is a diagram depicting the configuration of a management apparatus according to an embodiment of the present disclosure. As depicted in FIG. 9, the management apparatus 201 includes a communication unit 1, a detection unit 2, an analysis unit 3, and a storage unit 4. As one example, the communication unit 1, the detection unit 2, and the analysis unit 3 are partially or entirely realized by processing circuitry including one or a plurality of processors. One example of the storage unit 4 is a non-volatile memory included in such processing circuitry.

The communication unit 1 transmits and receives information to and from the vehicle-mounted apparatuses 101 via the external network 161. The communication unit 1 transmits setting information to the vehicle-mounted apparatuses 101. As one example, the setting information is registered in the storage unit 4 and updated by the user.

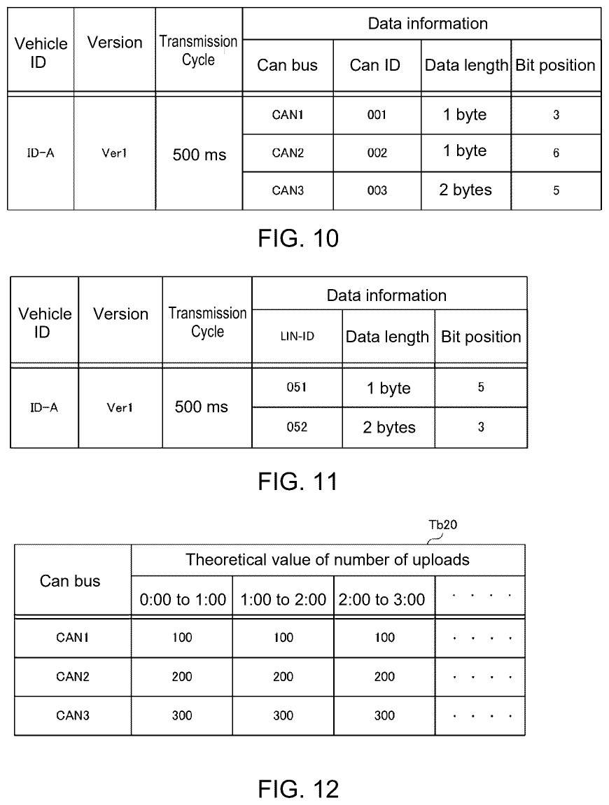

FIG. 10 is a diagram depicting one example of setting information stored by a management apparatus according to an embodiment of the present disclosure.

Like the example depicted in FIG. 10, the setting information may indicate correspondence between identification information of a vehicle, version information indicating the version, as one example, the latest version, of the setting information to be applied to a vehicle-mounted apparatus 101, transmission cycle information indicating a transmission cycle for transmitting vehicle information to the management apparatus 201, and data information for identifying the vehicle information. As one example, the data information indicates the correspondence between the CAN bus 51 on which CAN frames including the vehicle information are transmitted, the CAN-ID of the CAN frames, the data length, and the bit position of the vehicle information within each CAN frame.

In the example depicted in FIG. 10, the version of the setting information to be applied to the vehicle-mounted apparatus 101 of the vehicle 10 with the vehicle ID “ID-A” is “Ver1”. The transmission cycle for transmitting the vehicle information is 500 milliseconds. The vehicle-mounted apparatus 101 uploads vehicle information with a data length of “1 byte” and a bit position of “3”, which is stored in CAN frames with the CAN-ID “001” to be transferred on the CAN bus “CAN1”. The vehicle-mounted apparatus 101 also uploads vehicle information with a data length of “1 byte” and a bit position of “6”, which is stored in CAN frames with the CAN-ID “002” to be transferred on the CAN bus “CAN2”. The vehicle-mounted apparatus 101 also uploads vehicle information with a data length of “2 bytes” and a bit position of “5”, which is stored in CAN frames with the CAN-ID “003” to be transferred on the CAN bus “CAN3”.

FIG. 11 is a diagram depicting another example of the setting information stored by the management apparatus according to an embodiment of the present disclosure.

FIG. 11 depicts setting information for a case where the vehicle-mounted apparatus 101 and each vehicle-mounted device 111 communicate according to LIN standard. In this case, vehicle information transmitted from each vehicle-mounted device 111 via a bus is stored in a frame that has been assigned an LID-ID indicating the type of data and the like.

As one example, as depicted in FIG. 11, the setting information indicates correspondence between the identification information of a vehicle, version information indicating the version, as one example, the latest version, of the setting information to be applied to the vehicle mounted apparatus 101, transmission cycle information indicating a transmission cycle for transmitting vehicle information to the management apparatus 201, and data information for identifying the vehicle information. The data information indicates, for example, the correspondence between the LID-ID of a frame, the data length, and the bit position of the vehicle information within the frame.

In the example depicted in FIG. 11, the version of the setting information to be applied to the vehicle-mounted apparatus 101 of the vehicle 10 with the vehicle ID “ID-A” is “Ver1”. The transmission cycle of the vehicle information is 500 milliseconds. The vehicle-mounted apparatus 101 uploads vehicle information that is stored in a frame with the LID-ID “051”, has a data length of “1 byte”, and is at the bit position “5”. The vehicle-mounted apparatus 101 also uploads vehicle information that is stored in a frame with the LID-ID “052”, has a data length of “2 bytes”, and is at the bit position “3”.

As depicted in FIG. 9, the communication unit 1 stores the information received from the vehicle-mounted apparatus 101 in the storage unit 4. In more detail, the communication unit 1 receives vehicle information and measurement result information from the vehicle-mounted apparatus 101, and stores the received vehicle information and measurement result information in the storage unit 4.

The detection unit 2 performs a detection process to detect any abnormalities relating to the vehicle 10 based on the vehicle information and the measurement result information received from the vehicle-mounted apparatus 101.

In more detail, the detection unit 2 acquires a theoretical value of the number of uploads of vehicle information of the vehicle 10 corresponding to the identification information included in the vehicle information received by the communication unit 1. As a specific example, the detection unit 2 acquires a theoretical table Tb20 indicating a theoretical value of the number of uploads of vehicle information per unit time for each vehicle 10 from the storage unit 4. The theoretical table Tb20 is registered in advance in the storage unit 4 by the user, for example.

FIG. 12 is a diagram depicting one example of a theoretical table stored by a management apparatus according to an embodiment of the present disclosure.

As depicted in FIG. 12, the theoretical table Tb20 indicates a theoretical value for a plurality of time periods for the number of uploads of vehicle information transferred on each CAN bus 51. As one example in the theoretical table Tb20, the time periods are one hour, which is the same as the unit time in the calculation process by the vehicle-mounted apparatus 101.

In the theoretical table Tb20, the theoretical value of the number of uploads of vehicle information transmitted on the CAN bus “CAN1” is “100” for each of the periods between the times 0:00 and 1:00, 1:00 and 2:00, and 2:00 and 3:00. The theoretical value of the number of uploads of vehicle information transmitted on the CAN bus “CAN2” is “200” for each of the periods between the times 0:00 and 1:00, 1:00 and 2:00, and 2:00 and 3:00. The theoretical value of the number of uploads of vehicle information transmitted on the CAN bus “CAN3” is “300” for each of the periods between the times 0:00 and 1:00, 1:00 and 2:00, and 2:00 and 3:00.

The analysis unit 3 acquires a collection record table Tb21 which indicates the correspondence between a collection record of vehicle information that has been received by the communication unit 1 and measurement result information. As a specific example, the analysis unit 3 regularly or irregularly creates a collection record table Tb21 indicating the correspondence between a collection record of vehicle information and the measurement result information for each vehicle 10 based on the vehicle information and measurement result information stored in the storage unit 4, and stores the created table in the storage unit 4.

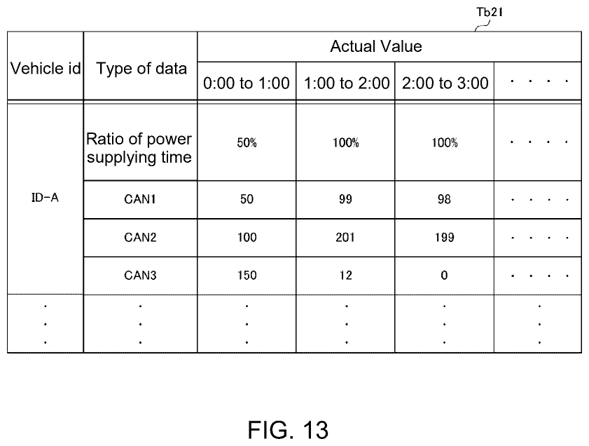

FIG. 13 is a diagram depicting one example of a collection record table stored by a management apparatus according to an embodiment of the present disclosure.

As depicted in FIG. 13, in the collection record table Tb21, the collection record is divided into a plurality of time periods. Each time period is one hour for example, like the time periods in the theoretical table Tb20. For the vehicle 10 with the vehicle ID “ID-A”, the actual number of uploads on the CAN bus “CAN1” is “50” from 0:00 to 1:00, “99” from 1:00 to 2:00, and “98” from 2:00 to 3:00. The actual number of uploads on the CAN bus “CAN2” is “100” from 0:00 to 1:00, “201” from 1:00 to 2:00, and “199” from 2:00 to 3:00. The actual number of uploads on the CAN bus “CAN2” is “150” from 0:00 to 1:00, “12” from 1:00 to 2:00, and “0” from 2:00 to 3:00.

In addition, for vehicle 10 with the vehicle ID “ID-A”, the actual value of the power supplying ratio is “50%” during the period between the times 0:00 to 1:00, “100%” from 1:00 to 2:00, and “100%” from 2:00 to 3:00.

The detection unit 2 performs a detection process based on the theoretical table Tb20 and the collection record table Tb21.

As a specific example, the detection unit 2 determines whether any of the numbers of uploads is abnormal. As one example, when the actual value of a number of uploads in the collection record table Tb21 is equal to or greater than a threshold Th, the detection unit 2 determines that that number of uploads is normal. On the other hand, when the actual value of a number of uploads in the collection record table Tb21 is less than the threshold Th, the detection unit 2 determines that that number of uploads is abnormal.

Here, as one example, the threshold Th is a value obtained by subtracting a predetermined value from the product of a theoretical value of the number of uploads of vehicle information transmitted via a CAN bus 51 during a time period subjected to the detection process and the power supplying ratio during that time period. By doing so, it is possible for the detection unit 2 to determine for example that the period during which power has been supplied by the ignition power supply 72 is short, meaning that the period during which vehicle information has been uploaded is short, resulting in a small number of uploads.

The predetermined value is 2, for example. In the following description, it is assumed that the thresholds Th for determining whether the number of uploads of vehicle information transmitted on the CAN buses “CAN1”, “CAN2”, and “CAN3” are abnormal are the thresholds Th1, Th2, and Th3 respectively.

### Determination of Abnormalities During Time Period from 0:00 to 1:00

As depicted in FIGS. 12 and 13, the thresholds Th1, Th2, and Th3 in the time period from 0:00 to 1:00 are 48, 98, and 148, respectively, due to the theoretical values of the corresponding number of uploads in such time periods being “100”, “200”, and “300”, the power supplying ratio in those periods being “50%”, and the predetermined value being “2”.

Since the actual number of uploads from 0:00 to 1:00 on the CAN bus “CAN1” is “50”, which is equal to or greater than the threshold Th1 that is “48”, the detection unit 2 determines that the number of uploads is normal.

Similarly, since the actual number of uploads from 0:00 to 1:00 on the CAN bus “CAN2” is “100”, which is equal to or greater than the threshold Th2 that is “98”, the detection unit 2 determines that the number of uploads is normal.

Since the actual number of uploads from 0:00 to 1:00 on the CAN bus “CAN3” is “150”, which is equal to or greater than the threshold Th3 that is “148”, the detection unit 2 determines that the number of uploads is normal.

### Determination of Abnormalities During Time Period from 1:00 to 2:00

The thresholds Th1, Th2, and Th3 in the time period from 1:00 to 2:00 are 98, 198, and 298, respectively, due to the theoretical values of the corresponding number of uploads in such time periods being “100”, “200”, and “300”, the power supplying ratio in those periods being “100%”, and the predetermined value being “2”.

Since the actual number of uploads from 1:00 to 2:00 on the CAN bus “CAN1” is “99”, which is equal to or greater than the threshold Th1 that is “98”, the detection unit 2 determines that the number of uploads is normal.

Similarly, since the actual number of uploads from 1:00 to 2:00 on the CAN bus “CAN2” is “201”, which is equal to or greater than the threshold Th2 that is “198”, the detection unit 2 determines that the number of uploads is normal.

Since the actual number of uploads from 1:00 to 2:00 on the CAN bus “CAN3” is “12”, which is less than the threshold Th3 that is “298”, the detection unit 2 determines that the number of uploads is abnormal.

### Determination of Abnormalities During Time Period from 2:00 to 3:00

The thresholds Th1, Th2, and Th3 in the time period from 2:00 to 3:00 are 98, 198, and 298, respectively, due to the theoretical values of the corresponding number of uploads in such time periods being “100”, “200”, and “300”, the power supplying ratio in those periods being “100%”, and the predetermined value being “2”.

Since the actual number of uploads from 2:00 to 3:00 on the CAN bus “CAN1” is “98”, which is equal to or greater than the threshold Th1 that is “98”, the detection unit 2 determines that the number of uploads is normal.

Similarly, since the actual number of uploads from 2:00 to 3:00 on the CAN bus “CAN2” is “199”, which is equal to or greater than the threshold Th2 that is “198”, the detection unit 2 determines that the number of uploads is normal.

Since the actual number of uploads from 2:00 to 3:00 on the CAN bus “CAN3” is “0”, which is less than the threshold Th3 that is “298”, the detection unit 2 determines that the number of uploads is abnormal.

The detection unit 2 outputs the detection result for abnormalities. As examples, the detection unit 2 stores the detection result for abnormalities in the storage unit 4 and/or gives notification of the detection result for abnormalities.

### Request for New Setting Information

As depicted in FIGS. 2, 4 and 12, at the vehicle-mounted apparatus 101, for example, the first communication unit 11 transmits version information indicating the version of the setting information held by the vehicle-mounted apparatus 101 to the management apparatus 201. The first communication unit 11 then requests the management apparatus 201 to transmit new setting information, based on determination information that has been transmitted from the management apparatus 201 and indicates a determination result for the version indicated by the version information. That is, in the communication system 501, an updating process for the setting information is performed.

In more detail, the first communication unit 11 transmits the version information included in the setting information in the storage unit 16 regularly or irregularly to the management apparatus 201.

The management apparatus 201 determines whether the version indicated by the version information received from the vehicle-mounted apparatus 101 is the same as the version of the setting information stored in the management apparatus 201. If the version indicated by the version information received from the vehicle-mounted apparatus 101 differs from the version of the setting information stored by the management apparatus 201, the management apparatus 201 transmits negative determination information indicating a determination result that the versions are different to the vehicle-mounted apparatus 101.

At the vehicle-mounted apparatus 101, when the first communication unit 11 has received the negative determination information from the management apparatus 201, the first communication unit 11 transmits request information, which requests the management apparatus 201 to transmit new setting information, to the management apparatus 201. As one example, the first communication unit 11 transmits request information including the ID of the vehicle 10 in which this vehicle-mounted apparatus 101 is mounted to the management apparatus 201.

On receiving the request information from the vehicle-mounted apparatus 101, the management apparatus 201 transmits new setting information to the vehicle-mounted apparatus 101.

As a specific example, when the management apparatus 201 has received request information from the vehicle-mounted apparatus 101, the management apparatus 201 transmits, out of the setting information stored in the storage unit 4, setting information that corresponds to the ID of the vehicle 10 included in the received request information as new setting information to the vehicle-mounted apparatus 101.

At the vehicle-mounted apparatus 101, on receiving the new setting information from the management apparatus 201, the first communication unit 11 outputs the received setting information to the setting unit 12.

On receiving the new setting information from the first communication unit 11, the setting unit 12 stores the new setting information in the storage unit 16 and updates the setting content relating to the transmission of vehicle information based on the new setting information. The vehicle information acquisition unit 31 acquires vehicle information in accordance with this new setting content.

### Flow of Operations

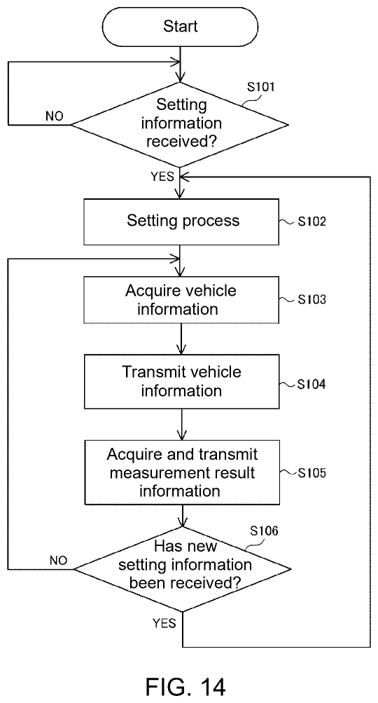

FIG. 14 is a flowchart defining an operational procedure when vehicle information and measurement result information are transmitted to a management apparatus by a vehicle-mounted apparatus according to an embodiment of the present disclosure.

As depicted in FIG. 14, first, the vehicle-mounted apparatus 101 stands by for transmission of the vehicle information until setting information is received from the management apparatus 201 (“NO” in step S101).

Next, when the vehicle-mounted apparatus 101 has received the setting information from the management apparatus 201 (“YES” in step S101), the vehicle-mounted apparatus 101 performs a setting process relating to the transmission of vehicle information based on the received setting information. As one example, as described earlier, as the setting process, the vehicle-mounted apparatus 101 makes settings so that vehicle information corresponding to the type of data indicated by the setting information is transmitted to the management apparatus 201 (step S102).

Next, the vehicle-mounted apparatus 101 regularly or irregularly acquires the vehicle information (step S103).

After this, the vehicle-mounted apparatus 101 selects vehicle information out of the acquired vehicle information in accordance with the setting content and transmits the selected vehicle information to the management apparatus 201 (step S104).

After this, the vehicle-mounted apparatus 101 acquires the measurement result information and transmits the measurement result information to the management apparatus 201. As one example, as described earlier, the vehicle-mounted apparatus 101 transmits measurement result information including a measurement result relating to the ignition power supply 72 to the management apparatus 201. In more detail, the vehicle-mounted apparatus 101 calculates the power supplying ratio and transmits measurement result information including this calculation result to the management apparatus 201 (step S105). Note that steps S104 and S105 may be executed in reverse order or in parallel.

Next, the vehicle-mounted apparatus 101 repeats the transmission of the acquired vehicle information and measurement result information (steps S103 to S105) until new setting information is received from the management apparatus 201 (“NO” in step S106).

On the other hand, when the vehicle-mounted apparatus 101 has received new setting information from the management apparatus 201 (“YES” in step S106), the vehicle-mounted apparatus 101 performs a setting process relating to the transmission of vehicle information based on the new setting information that has been received (step S102).

In this way, the vehicle mounted apparatus 101 performs the setting process relating to the transmission of vehicle information based on the setting information transmitted from the management apparatus 201, so that even in a situation where a vehicle-mounted apparatus 101 is installed in the vehicle 10 after the vehicle 10 has left the factory and the vehicle information to be transmitted to the management apparatus 201 is unknown, the vehicle-mounted apparatus 101 can select the vehicle information to be transmitted to the management apparatus 201 in the same way as a vehicle-mounted apparatus installed before the vehicle 10 leaves the factory.

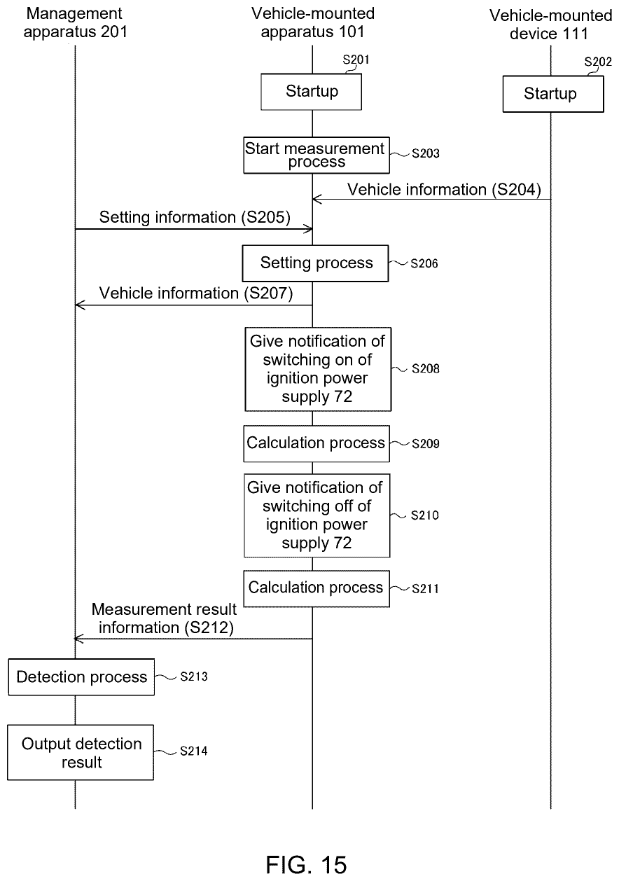

FIG. 15 is a diagram depicting one example of a processing sequence of a vehicle-mounted apparatus and a management apparatus in a communication system according to an embodiment of the present disclosure.

As depicted in FIG. 15, first, the vehicle mounted apparatus 101 starts up when electrical power is supplied from the battery 71 (step S201). The vehicle-mounted devices 111 also start up when electrical power is supplied from the battery 71 (step S202).

Next, the vehicle-mounted apparatus 101 starts a calculation process for calculating the power supplying ratio. The vehicle-mounted apparatus 101 sequentially stores calculation results in the storage unit 16 (step S203).

After this, the vehicle-mounted apparatus 101 regularly or irregularly acquires vehicle information from the vehicle-mounted devices 111 (step S 204).

Next, the management apparatus 201 transmits setting information, which indicates the setting content of the vehicle 10 relating to the transmission of vehicle information, to the vehicle mounted apparatus 101 (step S 205).

Next, the vehicle-mounted apparatus 101 performs the setting process relating to the transmission of vehicle information based on the setting information received from the management apparatus 201. As one example, as described earlier, the vehicle-mounted apparatus 101 performs the setting process so that vehicle information corresponding to the CAN-ID indicated in the received setting information is transmitted to the management apparatus 201 (step S206).

After this, the vehicle-mounted apparatus 101 selects vehicle information out of the acquired vehicle information in accordance with the setting content and transmits the selected vehicle information to the management apparatus 201 (step S207).

Next, when the vehicle-mounted apparatus 101 has detected that the ignition power supply 72 has been switched to the on state, the vehicle-mounted apparatus 101 synchronizes its time with another apparatus and stores the present time in the storage unit 16 as the start time of the calculation process for calculating the power supplying ratio (step S208).

After this, the vehicle-mounted apparatus 101 performs the calculation process. As one example, as described earlier, the vehicle-mounted apparatus 101 calculates the power supplying ratio every time a unit time elapses from a reference time set in advance. The vehicle-mounted apparatus 101 stores the calculation result in the storage unit 16 (step S209).

Next, when the vehicle-mounted apparatus 101 has detected that the ignition power supply 72 has been switched to the OFF state (step S210), the vehicle-mounted apparatus 101 stores the present time at which the switch to the OFF state was detected as the end time in the storage unit 16. The vehicle-mounted apparatus 101 then calculates the power supplying ratio at the end time, and stores the calculation result in the storage unit 16 (step S211).

After this, the vehicle-mounted apparatus 101 creates measurement result information including the calculation results obtained from the start time to the end time, and transmits the created measurement result information to the management apparatus 201 (step S 212).

Next, the management apparatus 201 performs the detection process based on the vehicle information and the measurement result information received from the vehicle-mounted apparatus 101 (step S213).

After this, the management apparatus 201 outputs a detection result for abnormalities. As one example, the management apparatus 201 stores the detection result for abnormalities in the storage unit 4 and/or gives notification of the detection result for abnormalities (step S214).

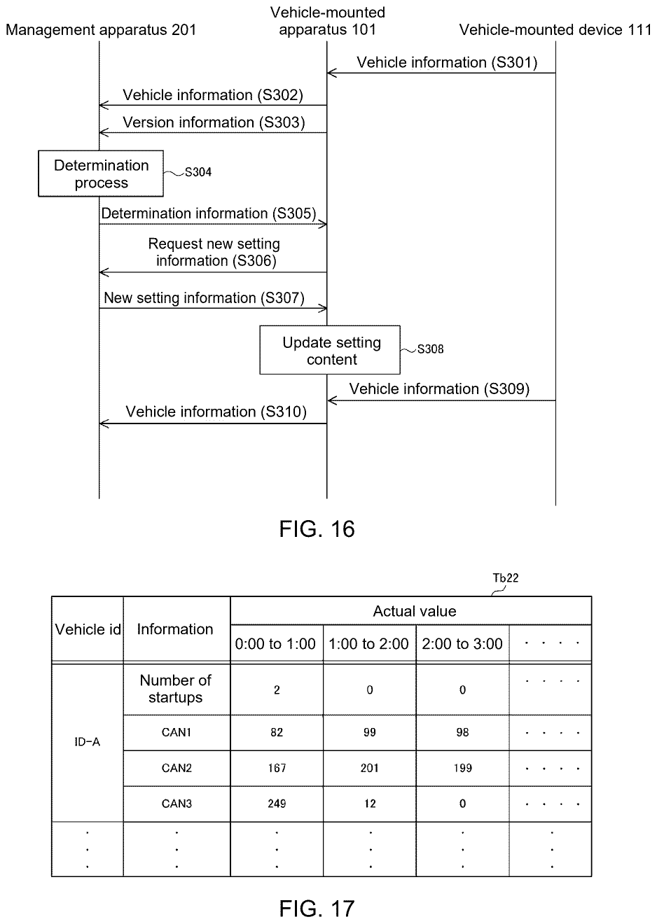

FIG. 16 is a diagram depicting the sequence of an updating process for setting information in a communication system according to an embodiment of the present disclosure.

As depicted in FIG. 16, first, the vehicle-mounted apparatus 101 regularly or irregularly acquires vehicle information from the vehicle-mounted devices 111 (step S301).

Next, the vehicle-mounted apparatus 101 selects vehicle information out of the acquired vehicle information in accordance with the setting content. The vehicle-mounted apparatus 101 then transmits the selected vehicle information to the management apparatus 201 (step S 302).

After this, the vehicle-mounted apparatus 101 transmits version information indicating the version of the setting information held in the vehicle-mounted apparatus 101 to the management apparatus 201 (step S 303).

Next, the management apparatus 201 performs a determination process to determine whether the version indicated by the version information received from the vehicle-mounted apparatus 101 is the same as the version of the setting information stored by the management apparatus 201 (step S304).

After this, the management apparatus 201 transmits determination information indicating a determination result for the version indicated by the version information received from the vehicle-mounted apparatus 101 to the vehicle-mounted apparatus 101. It is assumed here that the management apparatus 201 transmits, as the determination information, negative determination information indicating the determination result that the version indicated by the version information received from the vehicle-mounted apparatus 101 differs from the version of the setting information held by the management apparatus 201 (step S305).

Next, when the vehicle-mounted apparatus 101 has received the negative determination information, the vehicle-mounted apparatus 101 transmits request information, which requests the management apparatus 201 to transmit new setting information, to the management apparatus 201 (step S 306).

After this, when the management apparatus 201 has received the request information from the vehicle-mounted apparatus 101, the management apparatus 201 transmits new setting information to the vehicle-mounted apparatus 101 (step S307).

Next, the vehicle-mounted apparatus 101 updates a setting content relating to the transmission of vehicle information based on the new setting information received from the management apparatus 201 (step S308).

Next, the vehicle-mounted apparatus 101 newly acquires vehicle information (step S309).

After this, the vehicle-mounted apparatus 101 selects vehicle information out of the newly acquired vehicle information in accordance with the updated setting content, and transmits the selected vehicle information to the management apparatus 201 (step S 310).

### Modification 1

Although the vehicle-mounted apparatus 101 according to an embodiment of the present disclosure is configured so that the measurement result information acquisition unit 32 acquires information including the power supplying ratio as measurement result information including measurement results related to the ignition power supply 72, the present disclosure is not limited to this. The acquisition unit 13 may acquire, as the measurement result information, information including the number of times the ignition power supply 72 has started up per predetermined unit time.

In Modification 1, the measurement unit 62 in the measurement result information acquisition unit 32 counts the number of times the ignition power supply 72 starts up per unit time. As one example, when time has been synchronized between the vehicle-mounted apparatus 101 to which the measurement unit 62 belongs and a GPS receiver, the measurement unit 62 counts the number of times the ignition power supply 72 switches from an off state to an on state per unit time.

FIG. 17 is a diagram depicting one example of a collection record table stored in Modification 1 of a management apparatus according to an embodiment of the present disclosure.

In the collection record table Tb22 depicted in FIG. 17, the actual number of uploads on the CAN bus “CAN1” of the vehicle 10 with the vehicle ID “ID-A” from 0:00 to 1:00 is “82”, is “99” from 1:00 to 2:00, and is “98” from 2:00 to 3:00. The actual number of uploads on the CAN bus “CAN2” of the vehicle 10 with the vehicle ID “ID-A” is “167” from 0:00 to 1:00, “201” from 1:00 to 2:00, and “199” from 2:00 to 3:00. The actual number of uploads on the CAN bus “CAN3” of the vehicle 10 with the vehicle ID “ID-A” is “249” from 0:00 to 1:00, “12” from 1:00 to 2:00, and “0” from 2:00 to 3:00.

In addition, in the collection record table Tb22 depicted in FIG. 17, the actual value of the number of times the vehicle 10 with the vehicle ID “ID-A” starts up is “2” from 0:00 to 1:00, “0” from 1:00 to 2:00, and “0” from 2:00 to 3:00.

In Modification 1, the detection unit 2 of the management apparatus 201 performs a detection process based on the theoretical table Tb20 and the collection record table Tb22.

In this example, at the vehicle 10, it takes time for the vehicle-mounted system including the vehicle-mounted apparatus 101, the vehicle-mounted devices 111, and the like to start up and for the vehicle mounted system to shut down. For this reason, the period during which power is supplied to the vehicle-mounted apparatus 101 is given for example as a result of subtracting the product of a total time, which is the time required for the vehicle-mounted to start up plus the time required for the vehicle-mounted system to shut down, by the number of startups from the unit time.

As one example, consider a case where the unit time is 1 hour, the total time is 5 minutes, and the number of startups is 2. In this case, the time during which power is supplied to the vehicle-mounted apparatus 101 is 50 minutes, which is the value obtained by subtracting 10 minutes from 1 hour. In other words, the ratio of the power supplying time per unit time when the number of startups is 2 is approximately 80%.

In Modification 1, when the actual value of a number of uploads in the collection record table Tb22 is less than a threshold Th, the detection unit 2 determines that the number of uploads is abnormal. In Modification 1, the threshold Th is for example a value that is the product of a theoretical value of the number of uploads of vehicle information transmitted via the CAN bus 51 in a time period subjected to a detection process and a power supplying ratio in keeping with the number of startups in that time period. As a result, in Modification 1, the detection unit 2 can determine for example that the number of uploads is low because the ignition power supply 72 has started up many times and the periods during which the vehicle information was uploaded are short.

In the example depicted in FIGS. 12 and 17, as examples, the power supplying ratio in keeping with the number of startups is 80% when the number of startups is “2”, and is 100% when the number of startups is “0”.

### Determination of Abnormalities During Time Period from 0:00 to 1:00

In the example depicted in FIG. 12 and FIG. 17, the thresholds Th1, Th2, and Th3 during the time period from 0:00 to 1:00 are 80, 160, and 240, respectively due to the theoretical values of the corresponding number of uploads in such time period being “100”, “200”, and “300”, respectively, and the number of startups in that time period being “2”.

Since the actual number of uploads from 0:00 to 1:00 on the CAN bus “CAN1” is “82”, which is equal to or greater than the threshold Th1 that is “80”, the detection unit 2 determines that the number of uploads is normal.

Similarly, since the actual number of uploads from 0:00 to 1:00 on the CAN bus “CAN2” is “167”, which is equal to or greater than the threshold Th2 that is “160”, the detection unit 2 determines that the number of uploads is normal.

Since the actual number of uploads from 0:00 to 1:00 on the CAN bus “CAN3” is “249”, which is equal to or greater than the threshold Th3 that is “240”, the detection unit 2 determines that the number of uploads is normal.

Note that in Modification 1, the result of the determination of abnormalities during the time period from 01:00 to 02:00 and the result of the determination of abnormalities during the time period from 02:00 to 03:00 are the same as the case illustrated in FIG. 13.

### Modification 2

Although the vehicle-mounted apparatus 101 according to an embodiment of the present disclosure is configured so that the measurement result information acquisition unit 32 acquires information including a measurement result relating to the ignition power supply 72 as the measurement result information, the present disclosure is not limited to this. The measurement result information acquisition unit 32 may acquire information including a measurement result relating to communication quality between the first communication unit 11 and the management apparatus 201.

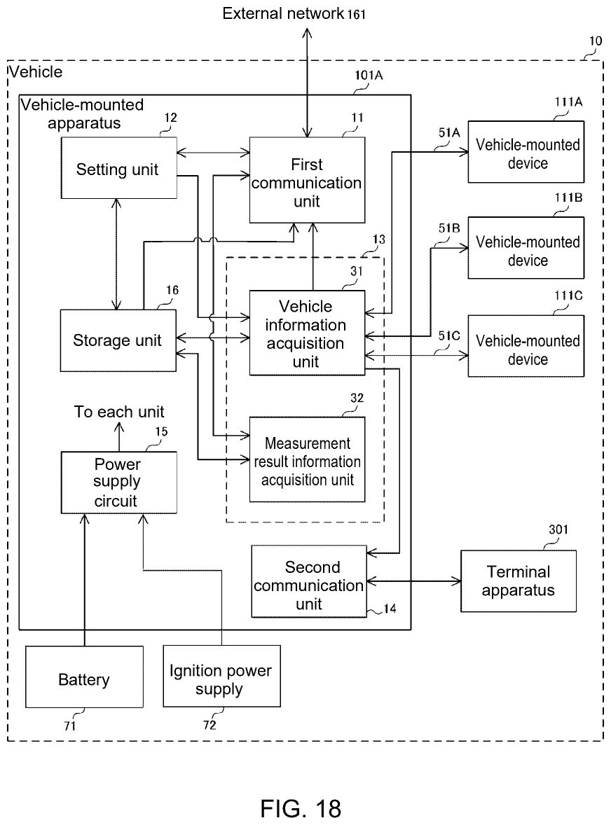

FIG. 18 is a diagram depicting the configuration of Modification 2 of a vehicle-mounted apparatus according to an embodiment of the present disclosure. As depicted in FIG. 18, as one example the first communication unit 11 in a vehicle-mounted apparatus 101A measures the SNR (Signal to Noise Ratio) of a wireless signal which has been received from a wireless base station, not illustrated, and includes information from the management apparatus 201. That is, in Modification 2, the object of measurement that affects the transmission of vehicle information is the first communication unit 11. Here, the higher the SNR, the lower the noise and the better the wireless signal quality.

The first communication unit 11 measures the SNR of the wireless signal received by the first communication unit 11 for each unit period during a predetermined measurement period. Here, the unit time is one hour, for example. The first communication unit 11 outputs the measurement result for each unit period to the measurement result information acquisition unit 32.

The measurement result information acquisition unit 32 acquires a measurement result of the SNR of the wireless signal produced by the first communication unit 11. In more detail, the measurement result information acquisition unit 32 creates measurement result information including measurement results for each unit period in a predetermined period, and transmits the created measurement result information to the management apparatus 201 via the first communication unit 11.

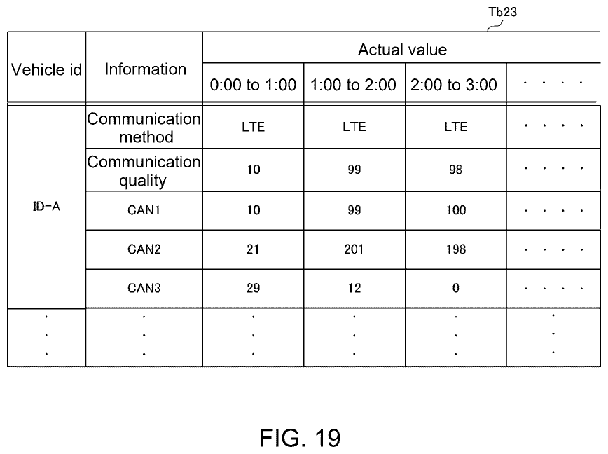

FIG. 19 is a diagram depicting one example of a collection record table stored by Modification 2 of a management apparatus according to an embodiment of the present disclosure.

In a collection record table Tb23 depicted in FIG. 19, the actual number of uploads on the CAN bus “CAN1” of the vehicle 10 with the vehicle ID “ID-A” is “10” from 0:00 to 1:00, “99” from 1:00 to 2:00, and “100” from 2:00 to 3:00. The actual number of uploads on the CAN bus “CAN2” of the vehicle 10 with the vehicle ID “ID-A” is “21” from 0:00 to 1:00, “201” from 1:00 to 2:00, and “198” from 2:00 to 3:00. The actual number of uploads on the CAN bus “CAN3” of the vehicle 10 with the vehicle ID “ID-A” is “29” from 0:00 to 1:00, “12” from 1:00 to 2:00, and “0” from 2:00 to 3:00.

In the collection record table Tb23 depicted in FIG. 19, the communication method between the vehicle 10 and the management apparatus 201 is “LTE”.

In addition, in the collection record table Tb23 depicted in FIG. 19, the actual value of the communication quality at the vehicle 10 with the vehicle ID “ID-A” is “10” from 0:00 to 1:00, “99” from 1:00 to 2:00, and “98” from 2:00 to 3:00.

In Modification 2, the detection unit 2 in the management apparatus 201 performs a detection process based on the theoretical table Tb20 and the collection record table Tb23.

In more detail, in Modification 2, when the record value of the number of uploads in the collection record table Tb23 is less than a threshold Th, the detection unit 2 determines that the number of uploads is abnormal. In Modification 2, the threshold value Th is a value obtained by subtracting a predetermined value from the product of the theoretical value of the number of uploads of vehicle information transferred via the CAN bus 51 in a time period subjected to the detection process and a percentage representing the actual communication quality in that time period. Here, the predetermined value is 2, for example.

### Determination of Abnormalities During Time Period from 0:00 to 1:00

As depicted in FIG. 12 and FIG. 19, the thresholds Th1, Th2, and Th3 during the time period from 0:00 to 1:00 are 8, 18, and 28, respectively due to the theoretical values of the corresponding number of uploads in such time period being “100”, “200”, and “300”, respectively, the communication quality in that communication period being “10”, and the predetermined value being “2”.

Since the actual number of uploads from 0:00 to 1:00 on the CAN bus “CAN1” is “10”, which is equal to or greater than the threshold Th1 that is “8”, the detection unit 2 determines that the number of uploads is normal.

Similarly, since the actual number of uploads from 0:00 to 1:00 on the CAN bus “CAN2” is “21”, which is equal to or greater than the threshold Th2 that is “18”, the detection unit 2 determines that the number of uploads is normal.

Since the actual number of uploads from 0:00 to 1:00 on the CAN bus “CAN3” is “29”, which is equal to or greater than the threshold Th3 that is “28”, the detection unit 2 determines that the number of uploads is normal.

Note that in Modification 2, the result of the determination of abnormalities during the time period from 01:00 to 02:00 and the result of the determination of abnormalities during the time period from 02:00 to 03:00 are the same as the case illustrated in FIG. 13.

### Modification 3

Although the vehicle-mounted apparatus 101 according to the embodiment of the present disclosure is configured so that setting information is received from the management apparatus 201, the present disclosure is not limited to this. Each vehicle-mounted apparatus 101 may be configured to receive setting information from a terminal apparatus 301.

In Modification 3, the vehicle information acquisition unit 31 in the acquisition unit 13 acquires vehicle information based on setting information transmitted from a terminal apparatus 301, which is a separate apparatus that differs from the management apparatus 201.

In more detail, the second communication unit 14 outputs the setting information received from the terminal apparatus 301 to the setting unit 12. On receiving the setting information from the second communication unit 14, the setting unit 12 stores the setting information in the storage unit 16 and performs a setting process relating to the transmission of vehicle information based on such setting information.

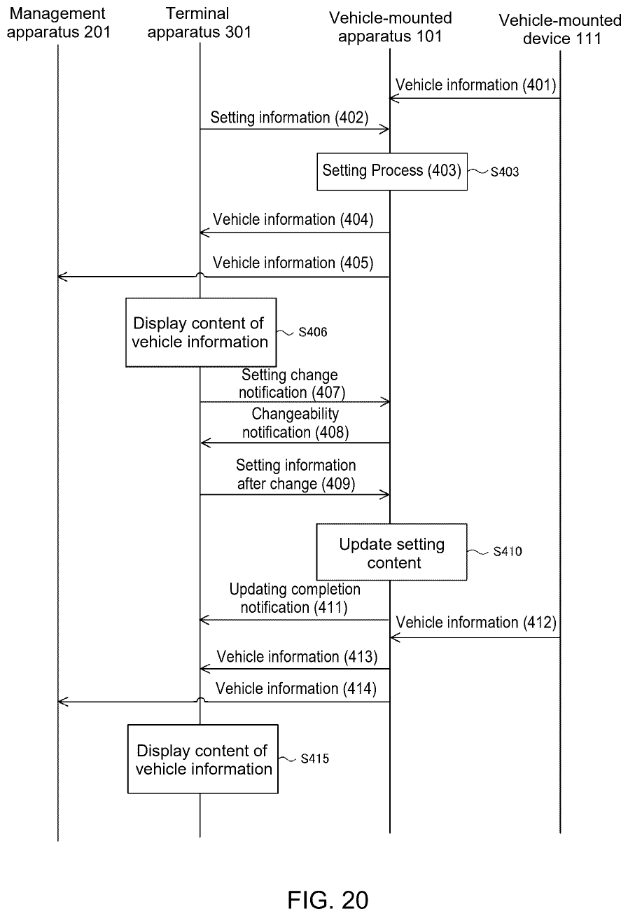

FIG. 20 is a diagram depicting the sequence of a setting process in Modification 3 to a communication system according to an embodiment of the present disclosure.

As depicted in FIG. 20, first, the vehicle-mounted apparatus 101 regularly or irregularly acquires vehicle information from a vehicle-mounted device 111 (step S401).

Next, the terminal apparatus 301 transmits setting information indicating a setting content of the vehicle 10 relating to the transmission of vehicle information to the vehicle-mounted apparatus 101. As one example, this setting information has been stored in the terminal apparatus 301 in keeping with a user operation (step S402).

After this, the vehicle-mounted apparatus 101 performs a setting process relating to the transmission of vehicle information based on the setting information received from the terminal apparatus 301. As one example, the vehicle-mounted apparatus 101 performs a setting process so that vehicle information corresponding to the CAN-ID indicated by the received setting information is transmitted to the terminal apparatus 301 (step S403).

Next, the vehicle-mounted apparatus 101 selects vehicle information out of the acquired vehicle information in keeping with the setting content, and transmits the selected vehicle information to the terminal apparatus 301 (step S 404). The vehicle-mounted apparatus 101 also transmits the selected vehicle information to the management apparatus 201 (step S405).

After this, when the terminal apparatus 301 has received the vehicle information from the vehicle-mounted apparatus 101, the terminal apparatus 301 displays the content of the received vehicle information, as one example, on a display unit or the like of the terminal apparatus 301 (step S406).

Next, in accordance with an operation by the user for example, the terminal apparatus 301 transmits a setting change notification indicating that the setting information is to be changed to the vehicle-mounted apparatus 101 (step S407).

After this, the vehicle-mounted apparatus 101 transmits a changeability notification indicating whether the settings can be changed to the terminal apparatus 301 as a response to the setting change notification received from the terminal apparatus 301. In this example, the vehicle-mounted apparatus 101 transmits a notification indicating that the settings are changeable as the changeability notification to the terminal apparatus 301 (step S408).

Next, when the terminal apparatus 301 has received the changeability notification from the vehicle-mounted apparatus 101, the terminal apparatus 301 transmits setting information for after the change to the vehicle-mounted apparatus 101 (step S409).

After this, the vehicle-mounted apparatus 101 updates the setting content based on the new setting information received from the terminal apparatus 301 (step S410).

Next, the vehicle-mounted apparatus 101 transmits an updating completion notification indicating that the updating of the setting content has been completed to the terminal apparatus 301. Note that the vehicle-mounted apparatus 101 may also transmit the updating completion notification to the management apparatus 201 (step S411).

After this, the vehicle mounted apparatus 101 newly acquires vehicle information (step S412).

Next, the vehicle-mounted apparatus 101 selects vehicle information out of the newly acquired vehicle information in accordance with the updated setting content and transmits the selected vehicle information to the terminal apparatus 301 (step S413). The vehicle-mounted apparatus 101 also transmits the selected vehicle information to the management apparatus 201 (step S414).

Next, when the terminal apparatus 301 has newly received vehicle information from the vehicle-mounted apparatus 101, the terminal apparatus 301 displays the content of the received vehicle information on a display unit or the like of the terminal apparatus 301 (step S415).

Note that some or all of the functions of the management apparatus 201 according to the embodiment of the present disclosure may be provided by cloud computing. That is, the management apparatus 201 according to the embodiment of the present disclosure may be a cloud server constructed by a plurality of servers.

Although the object of measurement that affects the transmission of vehicle information for the communication system 501 according to the embodiment of the present disclosure is the ignition power supply 72, the present disclosure is not limited to this. The object of measurement that affects the transmission of vehicle information may be a different power supplying unit.

In addition, although the first communication unit 11 is configured in the communication system 501 according to the embodiment of the present disclosure to transmit version information indicating the version of stored setting information to the management apparatus 201, the present disclosure is not limited to this. The first communication unit 11 may be configured not to transmit the version information to the management apparatus 201. That is, in the vehicle-mounted apparatus 101, the setting content relating to the transmission of vehicle information does not need to be updated.

In addition, although the communication system 501 according to the embodiment of the present disclosure is configured so that the vehicle-mounted apparatus 101 includes the second communication unit 14 that transmits vehicle information to the terminal apparatus 301, the present disclosure is not limited to this. The vehicle-mounted apparatus 101 may be configured to not include the second communication unit 14 and to not transmit vehicle information to the terminal apparatus 301.

All features of the embodiments disclosed here are exemplary and should not be regarded as limitations on the present disclosure. The scope of the present disclosure is indicated by the patent claims, not the description given above, and is intended to include all changes within the meaning and scope of the wording of the claims and their equivalents.

The respective processes (or functions) in the embodiments described above is realized by processing circuitry that includes one or a plurality of processors. Such processing circuitry may be configured as an integrated circuit or the like that combines one or a plurality of memories, various analog circuits, and various digital circuits with the one or plurality of processors. The one or a plurality of memories mentioned above store programs (instructions) that cause the one or a plurality of processors to execute the respective processes described above. The one or a plurality of processors may execute the above processes according to a program read from the one or plurality of memories, or may execute the above processes according to a logic circuit designed in advance to execute the respective processes described above. The processors mentioned above may be any of a variety of processors that are compatible with computer control, such as a CPU (Central Processing Unit), a GPU (Graphics Processing Unit), a DSP (Digital Signal Processor), an FPGA (Field Programmable Gate Array), and an ASIC (Application Specific Integrated Circuit). Note that the plurality of physically separated processors may execute the processes described above through cooperation with each other. As one example, processors installed in a plurality of physically separated computers may cooperate with each other via a network, such as a LAN (Local Area Network), a WAN (Wide Area Network), or the Internet, to execute the processes described above. The programs may be installed into the memories via the network from an external server apparatus or the like, or may be distributed having been stored on a recording medium such as a CD-ROM (Compact Disc Read Only Memory), a DVD-ROM (Digital Versatile Disc Read Only Memory), or a semiconductor memory and may be installed into the memories from such recording medium.

The description given above further includes the features indicated below.

### Appendix 1

A vehicle-mounted apparatus mounted in a vehicle, comprising a processing circuit,
wherein the processing circuit
acquires vehicle information, which relates to the vehicle, and measurement result information, which includes a measurement result that relates to the vehicle-mounted apparatus and is for an object of measurement that affects transmission of the vehicle information, and
transmits the acquired vehicle information and the measurement result information to the management apparatus.

### Appendix 2

A communication control program for use in a vehicle-mounted apparatus mounted in a vehicle,
the communication control program causing a computer to function as:
an acquisition unit that acquires vehicle information, which relates to the vehicle, and measurement result information, which includes a measurement result of an object of measurement that relates to the vehicle-mounted apparatus and affects transmission of the vehicle information; and
a communication unit that transmits the vehicle information and the measurement result information acquired by the acquisition unit to a management apparatus.

1. A vehicle-mounted apparatus mounted in a vehicle, comprising:
an acquisition unit configured to acquire vehicle information, which relates to the vehicle, and measurement result information, which includes a measurement result that relates to the vehicle-mounted apparatus and is a measurement result of an object of measurement which affects transmission of the vehicle information; and
a communication unit configured to transmit the vehicle information and the measurement result information acquired by the acquisition unit to a management apparatus.

2. The vehicle-mounted apparatus according to claim 1, wherein the measurement result information includes a measurement result relating to a power supplying unit that supplies electrical power in the vehicle.

3. The vehicle-mounted apparatus according to claim 2, wherein the measurement result relating to the power supplying unit includes a ratio of time during which the electrical power is supplied by the power supplying unit per a predetermined unit time.

4. The vehicle-mounted apparatus according to claim 2, wherein the measurement result relating to the power supplying unit includes a number of times the power supplying unit starts up per a predetermined unit time.

5. The vehicle-mounted apparatus according to claim 1, wherein the measurement result information includes a measurement result relating to communication quality between the communication unit and the management apparatus.

6. The vehicle-mounted apparatus according to claim 1, wherein the acquisition unit acquires the vehicle information based on setting information transmitted from the management apparatus.

7. The vehicle-mounted apparatus according to claim 6,
wherein the communication unit transmits version information, which indicates a version of the currently stored setting information to the management apparatus, and
the communication unit requests the management apparatus to transmit new setting information based on determination information, which indicates a determination result on the version indicated by the version information, transmitted from the management apparatus.

8. The vehicle-mounted apparatus according to claim 1,
wherein the acquisition unit acquires the vehicle information based on setting information transmitted from another apparatus that differs from the management apparatus, and
the communication unit also transmits the vehicle information acquired by the acquisition unit to the other apparatus.

9. A communication control method for a vehicle-mounted apparatus mounted in a vehicle, comprising:
a step of acquiring vehicle information, which relates to the vehicle, and measurement result information, which includes a measurement result that relates to the vehicle-mounted apparatus and is a measurement result of an object of measurement which affects transmission of the vehicle information; and
a step of transmitting the acquired vehicle information and measurement result information to a management apparatus.

10. A communication system comprising:
a vehicle-mounted apparatus mounted in a vehicle; and
a management apparatus that detects an abnormality relating to the vehicle,
wherein the vehicle-mounted apparatus includes:
an acquisition unit configured to acquire vehicle information, which relates to the vehicle, and measurement result information, which includes a measurement result that relates to the vehicle-mounted apparatus and is a measurement result of an object of measurement which affects transmission of the vehicle information; and
a communication unit configured to transmit the vehicle information and the measurement result information acquired by the acquisition unit to the management apparatus, and
the management apparatus detects an abnormality based on the vehicle information and the measurement result information received from the communication unit.
